(19) United States
(12) Patent Application Publication
(10) Pub. No.: US 2011/0119510 A1
(43) Pub. Date: May 19, 2011

(54) APPARATUS AND METHOD FOR REDUCING POWER CONSUMPTION IN PORTABLE TERMINAL

(75) Inventor: Dong-Gyu AHN, Suwon-si (KR)

(73) Assignee: Samsung Electronics Co. Ltd., Suwon-si (KR)

(21) Appl. No.: 12/942,429

(22) Filed: Nov. 9, 2010

(30) Foreign Application Priority Data
Nov. 19, 2009 (KR) 10-2009-0111971

(51) Int. Cl. G06F 1/00

(52) U.S. Cl. 713/323

(57) ABSTRACT

An apparatus and method for reducing power consumption in a portable terminal are provided. The apparatus includes a mode manager for, if determining data reception before sleep mode entry, processing to convert a state of a controller into a wakeup state and to complete the data reception and, if determining data non-reception before the sleep mode entry, converting a state of the controller into a sleep state at the same time as the sleep mode entry.

### PRIORITY

This application claims benefit under 35 U.S.C. §119(a) of a Korean patent application filed in the Korean Intellectual Property Office on Nov. 19, 2009, and assigned Serial No. 10-2009-0111971, the entire disclosure of which is hereby incorporated by reference.

### BACKGROUND OF THE INVENTION

1. Field of the Invention

The present invention relates to an apparatus and method for reducing the power consumption of a portable terminal. More particularly, the present invention relates to an apparatus and method for minimizing power consumption in a portable terminal that enters a low power mode in the course of connection with an Access Point (AP).

2. Description of the Related Art

In recent years, portable terminals, a necessity to modern people, have become widely used. A service provider or a system manufacturer is competitively developing a related product (or a service) for differentiation from other enterprises.

For example, the portable terminals evolve into multimedia equipment for phone books, games, Short Message Service (SMS), Electronic (E)-mail messages, morning wakeup calls, MPEG-1 Audio Layer 3 (MP3) players, schedule management functions, digital cameras, Multimedia Message Service (MMS), and wireless Internet services, and provide a variety of services.

To make use of a packet data service including a multimedia message and wireless Internet, the portable terminal has to establish a connection with an Access Point (AP) of a corresponding service.

That is, the portable terminal uses the packet data service by transmitting data to the AP. In an environment where the AP does not exist, the portable terminal cannot use the packet data service.

As the portable terminal makes use of a battery of a limited life, in the absence of operation for a predetermined time, the portable terminal enters a sleep mode for the purpose of extending an available time of use.

The sleep mode is a mode of converting a state of a hardware module of the portable terminal into a sleep state. If the portable terminal enters the sleep mode in the course of data reception from the AP, the portable terminal keeps the hardware module in a wakeup state for a predetermined time to complete the data reception, before the sleep mode entry.

The sleep mode prevents the portable terminal from reestablishing a connection with the AP to again receive data after data reception has been discontinued.

Further, although the portable terminal enters the sleep mode in the course of data non-reception from the AP, the portable terminal keeps the hardware module in the wakeup state during the predetermined time before entering the sleep mode.

That the portable terminal entering the sleep mode forcibly maintains the wakeup state during the predetermined time as described above causes current consumption of several dozen of milliamperes (mA), thus reducing a time of use of the portable terminal.

Accordingly, there is a need for an apparatus and method for minimizing power consumption in a portable terminal entering a sleep mode.

### SUMMARY OF THE INVENTION

An aspect of the present invention is to address at least the above problems and/or disadvantages and to provide at least the advantages below. Accordingly, one aspect of the present invention is to provide an apparatus and method for minimizing the power consumption of a portable terminal that enters a low power mode in the course of connection with an Access Point (AP).

In accordance with an aspect of the present invention an apparatus and method for converting a state of a controller into a wakeup state, only in case of entering a low power mode in the course of data reception having connection with an AP in a portable terminal, are provided.

A further aspect of the present invention is to provide an apparatus and method for processing to operate in a power saving mode upon entering a low power mode in a portable terminal.

The above aspects are achieved by providing an apparatus and method for reducing power consumption in a portable terminal.

In accordance with an aspect of the present invention, an apparatus for reducing power consumption in a portable terminal is provided. The apparatus includes a mode manager for, if determining data reception before sleep mode entry, processing to convert a state of a controller into a wakeup state and complete the data reception, and, if determining data non-reception before sleep mode entry, converting a state of the controller into a sleep state at the same time of the sleep mode entry.

In accordance with another aspect of the present invention, a method for reducing power consumption in a portable terminal is provided. The method includes, if entering a sleep mode, determining data reception or non-reception before sleep mode entry, and if determining the data reception before sleep mode entry, waking up the controller and completing the data reception, and if determining the data non-reception before sleep mode entry, converting a state of the controller into a sleep state at the same time of the sleep mode entry.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings in which:

FIG. 1 is a block diagram illustrating a construction of a portable terminal of minimizing power consumption upon entering a low power mode in course of connection with an Access Point (AP) according to an exemplary embodiment of the present invention:

FIG. 2 is a flow diagram illustrating a process of, upon entering a low power mode in course of connection with an AP, minimizing power consumption in a portable terminal according to an exemplary embodiment of the present invention; and

FIG. 3 is a flow diagram illustrating a process of, upon entering a low power mode in the course of connection with an AP, minimizing power consumption in a portable terminal according to an exemplary embodiment of the present invention.

Throughout the drawings, it should be noted that like reference numbers are used to depict the same or similar elements, features, and structures.

### DETAILED DESCRIPTION OF THE PREFERRED EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following description is made for an apparatus and method for, only in a case of entering a low power mode in the course of data reception having connection with an Access Point (AP), converting a state of a controller into a wakeup state and minimizing power consumption in a portable terminal according to exemplary embodiments of the present invention.

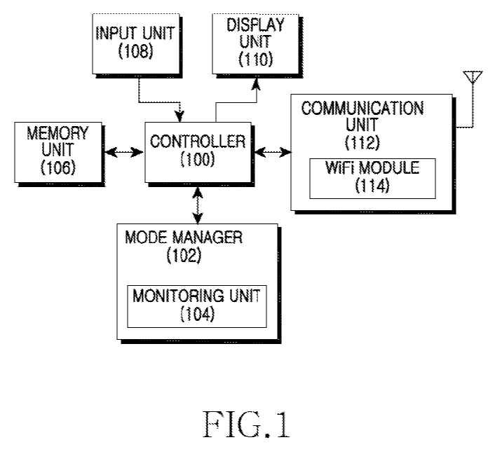

FIG. 1 is a block diagram illustrating a construction of a portable terminal for minimizing power consumption upon entering a low power mode in the course of connection with an AP according to an exemplary embodiment of the present invention.

Referring to FIG. 1, the portable terminal can include a controller 100, a mode manager 102, a memory unit 106, an input unit 108, a display unit 110, and a communication unit 112. The portable terminal may also include additional units that are not illustrated here merely for sake of clarity. Similarly, the functionality of two or more of the above units may be integrated into a single component without departing from the scope or spirit of the present invention.

The controller 100 of the portable terminal controls a general operation of the portable terminal. For example, the controller 100 performs processing and control for voice call and data communication. In addition to a general function, according to the present invention, the controller 100 processes to reduce the power consumption of the portable terminal entering a low power mode in course of communication with an AP.

To reduce the power consumption as described above, generally, the controller 100 keeps a data transmission/reception module (i.e., the controller 100 and the communication unit 112) in a wakeup state so as to prevent data transmission/reception from being discontinued upon sleep mode entry.

However, if the controller 100 enters the sleep mode according to the present invention, the controller 100 keeps only the communication unit 112 and the mode manager 102 in the wakeup state and converts a state of the remaining modules into a sleep state, thus minimizing power consumption. That is, after converting the state of the remaining module into the sleep state, the controller 100 itself also enters the sleep mode. This prevents a conventional power consumption generated as a controller maintains a wakeup state.

After that, the controller 100 is awakened by the mode manager 102 to receive data.

The mode manager 102 is a block for connecting with the communication unit 112 and controlling the controller 100. The mode manager 102 can include a monitoring unit 104. If the portable terminal enters the sleep mode, the mode manager 102 processes to convert a wakeup state of the controller 100 into a sleep state. After that, if the mode manager 102 determines that it receives a data transmission notification message through the monitoring unit 104, the mode manager 102 converts the sleep state of the controller 100 into the wakeup state.

The monitoring unit 104 of the mode manager 102 determines if a data transmission notification message is received through the communication unit 112, and provides the message reception or non-reception to the mode manager 102.

The memory unit 106 may include, for example, a Read Only Memory (ROM), a Random Access Memory (RAM), a flash ROM, and the like (not illustrated).

The ROM stores, for example, a microcode (i.e., code) of a program for processing and controlling the controller 100 and the mode manager 102 and a variety of kinds of reference data.

The RAM, a working memory of the controller 100, stores, for example, temporary data generated in execution of various kinds of programs. The flash ROM stores a diversity of kinds of updateable depository data, such as a phone book, an outgoing message, an incoming message, and information of a user touch input point.

The input unit 108 includes, for example, numeral key buttons ‘0’ to ‘9’, a menu button, a cancel button, an OK button, a talk button, an end button, an Internet button, navigation key buttons, and a plurality of function keys such as a character input key. The input unit 108 provides key input data (e.g., a low power mode entry request) corresponding to a key pressed by a user, to the controller 100.

The display unit 110 displays, for example, state information generated during operation of the portable terminal, limited number of characters, a large amount of moving pictures and still pictures, and the like. The display unit 110 can be a color Liquid Crystal Display (LCD), an Active Mode Organic Light Emitting Diode (AMOLED), and the like. In case that the display unit 110 includes a touch input device and is applied to a portable terminal of a touch input scheme, the display unit 110 can then also be used as an input device for the portable terminal.

The communication unit 112 performs a function of transmitting/receiving and processing a radio signal of data input/output through an antenna (not illustrated). For example, in a transmission mode, the communication unit 112 performs a function of processing original data through channel coding and spreading, converting the original data into a Radio Frequency (RF) signal, and transmitting the RF signal. In a reception mode, the communication unit 112 performs a function of converting a received RF signal into a baseband signal, processing the baseband signal through de-spreading and channel decoding, and restoring the signal to original data. According to the present invention, the communication unit 112 includes a Wireless Fidelity (WiFi) module 114, and establishes a communication correction with the AP. Also, the communication unit 112 receives a data transmission notification message from the AP and transmits the received message to the monitoring unit 104.

A function of the mode manager 102 can be implemented by the controller 100 of the portable terminal. However, these are separately constructed and shown in the Figures of present invention as an exemplary construction for description convenience, and never intend to limit the scope of the present invention. It shall be understood by those skilled in the art that various modifications of construction can be made within the scope and spirit of the present invention. For example, construction can also be such that all functions are processed in the controller 100.

The above description is made for an apparatus for, only in case of entering a low power mode in course of data reception having connection with an AP, converting a state of a controller into a wakeup state and minimizing power consumption in a portable terminal according to the present invention. The following description is made for a method for minimizing the power consumption of the portable terminal using the apparatus according to the present invention.

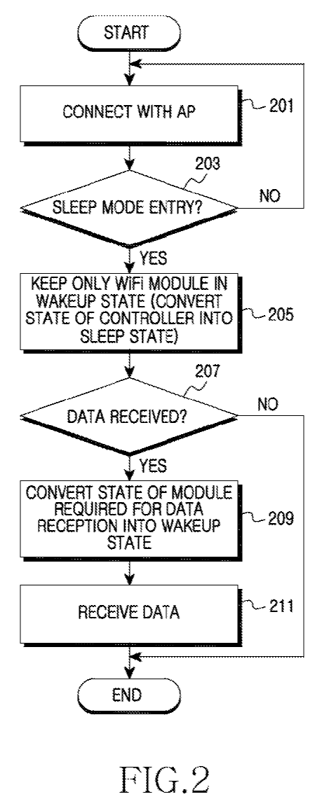

FIG. 2 is a flow diagram illustrating a process of, upon entering a low power mode in the course of connection with an AP, minimizing power consumption in a portable terminal according to an exemplary embodiment of the present invention.

Referring to FIG. 2, in step 201, the portable terminal performs a process of connecting with the AP and transmitting data through a WiFi module.

After that, the portable terminal proceeds to step 203 and determines whether it enters a sleep mode. Here, the sleep mode refers to a mode of converting a wakeup state of a module (i.e., a WiFi module, a controller, an output unit, and the like) of the portable terminal into a sleep state after a predetermined time to maximize a time of use of a limited battery capacity of the portable terminal. In the case that the portable terminal does not sense a control input by a user for a predetermined time or in the case that there is an input of a defined key for sleep mode entry, the portable terminal can enter the sleep mode.

The reason why the portable terminal maintains a wakeup state for a predetermined time without changing a state of the module of the portable terminal into a sleep state at the same time of sleep mode entry is to prevent a problem that, when the portable terminal enters a sleep mode in the course of transmitting/receiving data through the AP, the portable terminal discontinues the data transmission/reception that is under implementation.

Even in the absence of a function of preventing the discontinuation of data transmission/reception or in the absence of the data transmission/reception, the sleep mode keeps a data transmission/reception module in a wakeup state for a predetermined time and thus, the sleep mode reduces an available time of use of the portable terminal.

To solve the above problem, the portable terminal returns to step 201 and maintains a communication connection with the AP if it is determined that the sleep mode is not entered in step 203.

On the other hand, if the portable terminal determines that the sleep mode is entered in step 203, the portable terminal proceeds to step 205 and keeps only the WiFi module in a wakeup state and converts a state of the controller 100 into a sleep state. Here, the reason why the portable terminal keeps the WiFi module in the wakeup state is to determine the existence or non-existence of data transmitted by the AP.

After keeping only the WiFi module in the wakeup state as above, the portable terminal proceeds to step 207 and determines whether it receives data from the AP. Step 207 is a process of determining the existence or non-existence of data to be received by the portable terminal entering the sleep mode. In detail, step 207 is a process of determining whether the portable terminal is in the course of data reception before sleep mode entry or receives a data transmission request message from the AP after the sleep mode entry as described above.

That is, the portable terminal includes the mode manager 102 connecting with the WiFi module 114 and determining data reception. If receiving the data transmission request message from the AP, the mode manager 102 processes to convert the sleep state of the controller 100 into the wakeup state.

If the data reception is determined to not occur in step 207, the portable terminal either again performs step 205 and enables the sleep mode keeping the controller 100 in the sleep state (not illustrated), or terminates the procedure according to the exemplary embodiment of the present invention in the sleep mode keeping the controller 100 in the sleep state.

On the other hand, if the data reception is determined to occur in step 207, the portable terminal proceeds to step 209 and converts a sleep state of a module required for data reception into a wakeup state.

Here, the portable terminal converts a sleep state of the controller 100 into a wakeup state by the mode manager 102 according to the present invention.

After that, the portable terminal proceeds to step 211 and receives data using the wakeup state controller 100 of step 209 and the wakeup state WiFi module 114 of step 205.

After that, the portable terminal terminates the procedure according to the exemplary embodiment of the present invention.

In FIG. 2, a description is made for a process of, in the case of entering a sleep mode in course of data reception having connection with an AP, converting a state of the controller into a wakeup state and performing an operation of receiving the in-reception data and, in the case of entering the sleep mode in a state of data non-reception in course of connection with the AP, converting a state of the controller into a sleep state and minimizing power consumption in the portable terminal according to an exemplary embodiment of the present invention. That is, an aspect of the present invention is to minimize power consumption by converting a state of a hardware module of the portable terminal into a sleep state at the same time of a sleep mode entry request in case of not receiving data in connection with the AP.

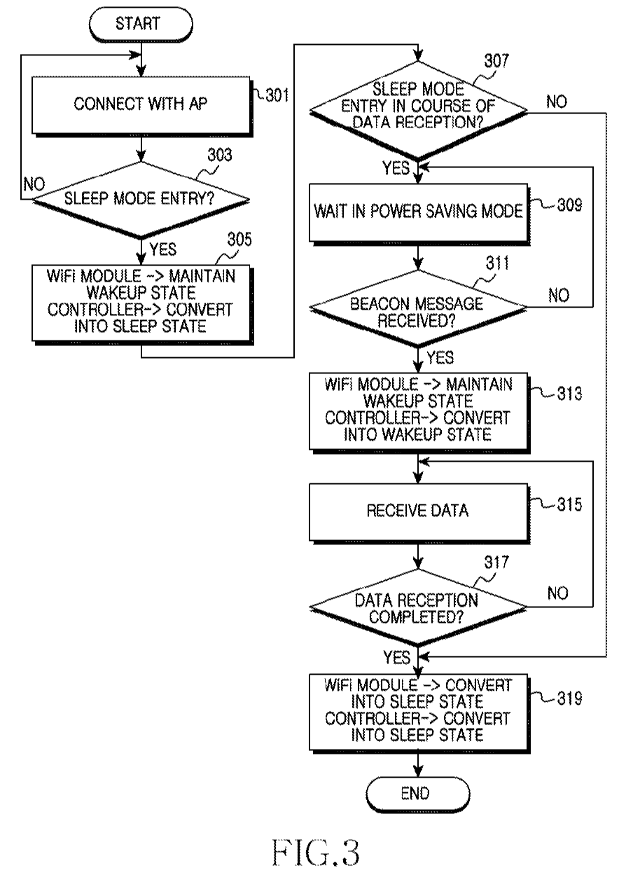

FIG. 3 is a flow diagram illustrating a process of, upon entering a low power mode in the course of connection with an AP, minimizing power consumption in a portable terminal according to an exemplary embodiment of the present invention.

Referring to FIG. 3, in step 301, the portable terminal performs a process of connecting with the AP and transmitting data through a WiFi module.

After that, the portable terminal proceeds to step 303 and determines whether it enters a sleep mode. Here, the sleep mode refers to a mode of converting a wakeup state of a module (i.e., a WiFi module, a controller, an output unit, and the like) of the portable terminal into a sleep state after a predetermined time to maximize an available time of use of a limited battery capacity of the portable terminal.

If the entry of the sleep mode is determined to not occur in step 303, the portable terminal returns to step 301 and maintains a connection with the AP.

On the other hand, if the entry of the sleep mode is determined to occur in step 303, the portable terminal proceeds to step 305 and, at the same time of the sleep mode entry, keeps only the WiFi module capable of receiving data from the AP, in a wakeup state and converts a wakeup state of the controller into a sleep state. That is, the sleep mode according to the present invention is a mode of keeping only the WiFi module capable of receiving data from the AP in the wakeup state.

After that, the portable terminal proceeds to step 307 and determines whether it enters the sleep mode in the course of data reception.

If the entry of the sleep mode in the course of data reception is determined to not occur in step 307, the portable terminal jumps to step 319 and converts the wakeup state of the WiFi module into a sleep state, and keeps the controller in the sleep state.

On the other hand, if the entry of the sleep mode in the course of data reception is determined to occur in step 307, the portable terminal proceeds to step 309 and enters a power saving mode and waits in the power saving mode.

After that, the portable terminal proceeds to step 311 and determines whether it receives a beacon message from the AP.

If the beacon message is not received in step 311, the portable terminal returns to step 309 and waits until receiving the beacon message.

On the other hand, if the beacon message is received in step 311, the portable terminal proceeds to step 313 and keeps the wakeup WiFi module in the wakeup state and converts the sleep state of the controller into the wakeup state to enable data reception.

Next, the portable terminal proceeds to step 315 and receives data from the AP. Then, the portable terminal proceeds to step 317 and determines whether it has completed the data reception.

If the completion of the data reception is determined to have not occurred in step 317, the portable terminal returns to step 315 and performs the data reception.

On the other hand, if the completion of the data reception is determined to have occurred in step 317, the portable terminal proceeds to step 319 and converts the wakeup state of the WiFi module into the sleep state, and converts the wakeup state of the controller into the sleep state. Then, the portable terminal terminates the procedure according to the exemplary embodiment of the present invention.

In FIG. 3, a description is made of a procedure of, if entering a sleep mode in the course of data reception having connection with an AP, in the case of applying a power saving technology and receiving a beacon message from the AP, converting a state of the controller into a wakeup state and receiving the in-reception data and, if entering the sleep mode in a state of data non-reception in the course of connection with the AP, converting the state of the controller into a sleep state, thus minimizing power consumption in a portable terminal according to the present invention.

However, the present invention controls a wakeup time of a WiFi module for determining data reception or non-reception, by enabling the power saving mode after sleep mode entry irrespective of data reception or non-reception in course of connection with the AP. That is, the present invention wakes up the WiFi module at predetermined time intervals and reduces power consumption resulting from the data reception determination.

As described above, the present invention relates to an apparatus and method for, only if entering a lower power mode in course of data reception having connection with an AP, convening a state of a controller into a wakeup state and minimizing power consumption in a portable terminal. The present invention can reduce power consumption caused by maintaining a wakeup state for a predetermined time upon sleep mode entry in a conventional portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for reducing power consumption in a portable terminal, the apparatus comprising:
a controller for controlling an operation of the portable terminal; and
a mode manager for, if determining data reception before sleep mode entry, processing to convert a state of the controller into a wakeup state and complete the data reception and, if determining data non-reception before sleep mode entry, converting the state of the controller into a sleep state at the same time of the sleep mode entry.

2. The apparatus of claim 1, wherein the sleep mode entry is determined if the portable terminal does not receive a user input for a predetermined period of time or if a predefined input for sleep mode entry is selected.

3. The apparatus of claim 1, wherein, upon sleep mode entry, the mode manager enables a power saving mode.

4. The apparatus of claim 3, wherein, upon sleep mode entry, the mode manager keeps only a Wireless Fidelity (WiFi) module, the module being capable of receiving a data transmission notification message from an Access Point (AP), in a wakeup state and converts the state of the controller into the sleep state.

5. The apparatus of claim 4, wherein, if receiving the data transmission notification message through the WiFi module maintaining the wakeup state in the sleep mode, the mode manager processes to convert the state of the controller controlling the data reception into the wakeup state and receive the data.

6. The apparatus of claim 5, wherein, if determining the data non-reception in the sleep mode, the mode manager converts the state of the controller and the state of the WiFi module into the sleep state.

7. A method for reducing power consumption in a portable terminal, the method comprising:
if entering a sleep mode, determining data reception or non-reception before sleep mode entry;
if determining the data reception before sleep mode entry, converting a state of a controller into a wakeup state and completing the data reception; and
if determining the data non-reception before sleep mode entry, converting the state of the controller into a sleep state at a same time as the sleep mode entry.

8. The method of claim 7, further comprising enabling a power saving mode if entering the sleep mode in a course of connection with an Access Point (AP).

9. The method of claim 8, further comprising, upon sleep mode entry, keeping only a Wireless Fidelity (WiFi) module, the module being capable of receiving a data transmission notification message from the AP, in a wakeup state and converting the state of the controller into the sleep state.

10. The method of claim 9, further comprising, if receiving the data transmission notification message through the WiFi module maintaining the wakeup state in the sleep mode:
converting the state of the controller controlling the data reception into the wakeup state; and
receiving the data using the wakeup state controller and WiFi module.

11. The method of claim 10, further comprising, after receiving the data, converting the state of the controller and the state of the WiFi module into the sleep state.

12. An apparatus for reducing power consumption in a portable terminal, the apparatus comprising:
a controller for controlling an operation of the portable terminal;
a Wireless Fidelity (WiFi) module for enabling data transmission/reception; and
a mode manager for, upon sleep mode entry, converting a state of the controller and a state of the WiFi module into a sleep state, and processing to convert the sleep state of the WiFi module into a wakeup state at predetermined time intervals,
wherein, if detecting data transmission/reception through the WiFi module while in the wakeup state, the mode manager converts the sleep state of the controller into the wakeup state.

13. The apparatus of claim 12, wherein, only if detecting the data transmission/reception, the mode manager converts the state of the controller into the wakeup state.

14. The apparatus of claim 12, wherein, if not detecting the data transmission/reception, the mode manager converts the state of the WiFi module into the sleep state.

15. The apparatus of claim 12, wherein the mode manager determines a beacon message received through the WiFi module and determines a wakeup time of the controller.

16. A method of reducing power consumption in a portable terminal comprising a controller for controlling an operation of the portable terminal, a Wireless Fidelity (WiFi) module for enabling data transmission/reception, and a mode manager for, upon sleep mode entry, converting a state of the controller and a state of the WiFi module into a sleep state, the method comprising:
the mode manager processing to convert the sleep state of the WiFi module into a wakeup state at predetermined time intervals; and
if detecting data transmission/reception through the WiFi Module while in the wakeup state, the mode manager converting the sleep state of the controller into the wakeup state.

17. The method of claim 16, further comprising, only if detecting the data transmission/reception, the mode manager converting the state of the controller into the wakeup state.

18. The method of claim 16, further comprising, if not detecting the data transmission/reception, the mode manager converting the state of the WiFi module into the sleep state.

19. The method of claim 16, further comprising the mode manager determining a beacon message received through the WiFi module and determining a wakeup time of the controller.
